(19) United States
(12) Patent Application Publication
(10) Pub. No.: US 2025/0263231 A1
(43) Pub. Date: Aug. 21, 2025

(54) LOAD HANDLING DEVICE WITH ASSIGNED CODE

(71) Applicant: OCADO INNOVATION LIMITED, Hatfield, Hertfordshire (GB)

(72) Inventor: Malte GRUBER, Hatfield, Hertfordshire (GB)

(73) Assignee: OCADO INNOVATION LIMITED, Hatfield, Hertfordshire (GB)

(21) Appl. No.: 18/858,512

(22) PCT Filed: Apr. 20, 2023
(86) PCT No.: PCT/EP2023/060357

§ 371 Date: Oct. 21, 2024

(30) Foreign Application Priority Data
Apr. 21, 2022 (GB) 2205825.9

(51) Int. Cl. B65G 1/04

(52) U.S. Cl. CPC B65G 1/0464; B65G 1/0478; B65G 2201/0235; B65G 2203/0216; B65G 2203/044

(57) ABSTRACT

A load handling device for lifting and moving containers stacked in stacks in a grid storage structure including a track system, the load handling device being configured to travel on the track system, the load handling device including a transmitter configured to transmit data and a receiver configured to receive the data from the transmitter; wherein the load handling device is assigned a code, such that the transmitter is configured to transmit the code along with the data and the receiver is configured to discard received data not including the code.

### TECHNICAL FIELD

The present invention relates to the field of load handling devices. In particular, the present invention relates to load handing devices for lifting and moving containers in a grid storage structure.

### BACKGROUND

Some commercial and industrial activities require systems that enable the storage and retrieval of a large number of different products. WO2015/185628A describes a storage and fulfilment system in which stacks of storage containers are arranged within a grid storage structure. The containers are accessed from above by load handling devices operative on the top of the grid storage structure.

A given load handling device lifts a target container from the top of a stack, the target container usually containing inventory items needed to fulfil a customer order. The load handling device typically comprises multiple parts, including a body for housing various components of the load handling device and a gripping device for engaging the target container. Communication between the various parts of the load handing device may be required and to enable this, a transmitter is positioned on one part and a receiver is positioned on another part of the load handling device. For successful communication to occur between the required parts, communication signals from the required transmitter need to be received by the receiver. However, interference between the transmitter and the receiver can prevent the receiver from receiving the required communication signals. This is further exacerbated in systems where multiple transmitters are provided which increase the risk of interference and cross talk.

It is against this background that the present invention has been devised.

### SUMMARY OF INVENTION

In a first aspect, there is provided a load handling device for lifting and moving containers stacked in stacks in a grid storage structure comprising a track system, the load handling device being configured to travel on the track system, the load handling device comprising:
a transmitter configured to transmit data and a receiver configured to receive the data from the transmitter;
wherein the load handling device is assigned a code, such that the transmitter is configured to transmit the code along with the data and the receiver is configured to discard received data not comprising the code.

By assigning a code to the load handling device such that the transmitter is configured to transmit the code (i.e. the assigned code) along with the data and the receiver is configured to discard received data not comprising the code (i.e. if the code is not received with the data), data from a transmitter (e.g. of another load handling device) will not be recognised by the receiver and thus will not be read by the receiver (or will be read as noise from the receiver). Thus, the code may be recognisable between the transmitter and the receiver of the load handling device. This advantageously prevents cross talk and interference from other data sources that may be present (e.g. from other transmitters or transmitters of other load handling devices). The above device can ensure that only the data required to be read by the receiver is recognised by the receiver. Preventing or reducing cross talk and interference to a load handling device is particularly advantageous, especially if data signal from the transmitter may be weak (e.g. the transmitter may be at a distance from the receiver) and/or if the transmitter may be configured to be moved away from the receiver such that the data signal from the transmitter may become weaker.

The transmitter and the receiver may be configured to communicate via wireless communication, e.g. optical communications. The transmitter may be configured to transmit optical transmissions. The transmitter may be a light transmitter that transmits data in the form of light signals, for example a Visible Light Communication (VLC), Li-Fi, Irda, Optical Wireless Communication (OWC) or Reasonable Optical Near Joint Access (RONJA). The transmitter may be a light emitting diode (LED). The receiver may be configured to receive optical transmissions. The receiver may be a light detector or a photo detector that can detect the optical transmissions (i.e. light signal) from the transmitter. Communication from the transmitter to the receiver may be dependent on the light intensity and/or the blink of the transmitter.

The transmitter may comprise a unidirectional transmitter configured to transmit directly to the receiver. The transmitter may comprise an omnidirectional transmitter configured to transmit signal in a plurality of directions or across a range of angles, e.g. a 100, 450, 900, 1800 or 3600 circumference around the transmitter.

The receiver may include a lens for focusing the data signal (e.g. the light signal) from the transmitter onto the receiver.

The load handling device may be assigned a code generated using code division multiple access (CDMA). This can ensure that the receiver may only correlate data received from a transmitter that has been assigned the same code as the receiver. The transmitter may be configured to send its data modulated by the assigned code. For example, the code may be a vector consisting of 1s and −1s or 1s and 0s or chips and for each bit of data sent by the transmitter the data may be modulated by the code assigned to the load handling device (e.g. the transmitter may blink for each element of the vector). In turn, the receiver may generate the vector code (or a copy of the vector code) assigned to the load handling device (and that the transmitter has sent) allowing the receiver to correlate the data received by the transmitter. The receiver may correlate the data received by the transmitter by multiplying the data received by its own copy of the vector code. When the receiver is configured to correlate the data received by the transmitter, the value obtained by the multiplication may be a positive number (e.g. a relatively large positive number), whereas if the receiver cannot correlate the data received by the transmitter (e.g. the receiver and the transmitter do not belong to the same load handling device), the value obtained by the multiplication may be a negative number (e.g. a relatively large negative number compared to the positive number obtained during successful correlation, or if the value obtained is close to zero, no data was received). In this way, the receiver can correlate the data received by the transmitter or discard data not comprising the code. This may be done so that the receiver can recognise whether the data received is from the transmitter of the same load handling device. The receiver may be configured to correlate the data received by the transmitter such that the receiver is configured to recognise only the data received from a transmitter whose data it has correlated with. For example, the receiver may be configured to recognise only the data received from a transmitter belonging to the same load handling device.

The load handling device may be assigned a unique code. The unique code may be assigned to the load handling device during manufacture of the load handling device.

The grid storage structure may accommodate containers stacked in stacks where the track system may be arranged above the stacks of containers. The load handling device may be configured to lift and move the containers. In particular, the load handling device may be configured to remove a container from the top of a stack and/or deposit a container onto the top of a stack. The track system may be arranged in a grid pattern above the stacks of containers. The track system may comprise a plurality of grid cells. Each grid cell may be allocated a predetermined code which may be assigned to the load handling device. The load handling device may be configured to move (i.e. travel) on the track system to specific grid cells (i.e. predetermined grid cell locations). In particular, the load handling device may be configured to move on the track system to a predetermined grid cell location such that it can retrieve a container from or deposit a container onto the top of a stack or a different location. The load handling device may be configured to travel on the track system to a predetermined grid cell location, where the code allocated to the grid cell location may be assigned to the load handling device (e.g. as the load handling device stops or parks on the predetermined grid cell location to retrieve or deposit a container). Thus, the code assigned to the load handling device may be dependent on the grid cell location of the load handling device. The load handling device may move to a new (i.e. different) grid cell location (e.g. to retrieve or deposit a container from a different stack). The load handling device may be assigned a new code, i.e. the code allocated to the new grid cell location of the load handling device. In particular, the load handling device may be configured to move to a first predetermined grid cell location where the load handling device may be assigned the code allocated to the first predetermined grid cell location. The load handling device may be configured to move (e.g. subsequently move) to a second predetermined grid cell location where the load handling device may be assigned the code allocated to the second grid cell location. Each time the load handling device moves to a different grid cell location, the load handling device may be assigned the code allocated to the new grid cell location of the load handling device.

The load handling device may comprise a communications interface configured to assign the code from an external communication manager. The codes may be assigned to the load handling device once it has stopped or parked at the predetermined grid cell location, i.e. the communications interface may be configured to assign the code to the load handling device once the load handling device has stopped at the predetermined grid cell location. The codes may be assigned to the load handling device before it arrives or stops/parks at the predetermined grid cell location, e.g. once the communication manager has determined the predetermined grid cell location for the load handling device or once the communication manager instructs the load handling device to move to the predetermined grid cell.

The load handling device may comprise a vehicle body and a gripping device. The load handling device may comprise a driving mechanism operatively arranged for moving the load handling device on the grid storage structure. The load handling device may comprise a container lifting assembly configured to raise and lower the gripping device relative to the body and for raising and lowering the containers. The gripping device may be configured to be moved away (e.g. lowered) from the body to a fully lowered position (e.g. when the gripping device is lowered onto a container and can engage with the container to be raised or when the gripping device is sufficiently lowered so as to deposit a container into an intended position). The gripping device may be configured to be moved or returned (e.g. raised) back to the body to a fully raised position (e.g. when the gripping device is above the track system (e.g. within the body) and/or when the gripping device is lifted to accommodate a container within the body). Thus, the gripping device may be moved between the fully raised position and the fully lowered position. The receiver may be coupled to the body, i.e. provided on the body. The transmitter may be coupled to the gripping device, i.e. provided on the gripping device. The transmitter may be configured to transmit information from the gripping device. The transmitter may be configured to transmit information about the gripping device (e.g. as it is moved away or lowered away from the body and as it is moved back or raised back to the body). For example, the transmitter may communicate or send data to the receiver about the gripping device status, whether the gripping device is engaged or disengaged with a container, the gripping device position (e.g. between its fully raised position and its fully lowered position) and/or the speed at which the gripping device is travelling (e.g. as it is being lowered or raised) etc.

The load handling device may comprise a controller which may be connectable to the receiver and/or the transmitter. The controller may be provided on the load handling device (e.g. in the body of the load handling device) and may be configured to control operation of (i.e. provide instructions to) the body and/or the gripping device. The controller may be configured to interpret the data received by the receiver and determine information about the body or the gripping device based on the data. In embodiments where the transmitter is coupled to the gripping device, the controller may be connectable to the receiver and may be configured to interpret the data received by the receiver and determine information about the gripping device based on the data, including for example, the position of the gripping device (e.g. between the fully raised position and the fully lowered position), whether the gripping device has engaged and/or disengaged with a container, the speed at which the gripping device is travelling etc. Based on the information received, the controller may be configured to provide instructions to the body and/or the gripping device, including for example, controlling the speed of the gripping device as it travels, instruct the gripping device to engage or dis-engage with a container etc.

A receiver may be coupled to (i.e. provided on) the gripping device and a transmitter may be coupled to (i.e. provided on) the body. This may be instead of or in addition to the transmitter on the gripping device and the receiver on the body, as described above. In these embodiments, the controller may be connectable to the receiver on the gripping device and may be configured to interpret data received by the receiver and determine information about the body based on the data. The transmitter on the body may also be configured to send information and/or instructions to the receiver on the gripping device, such as instructing the gripping device to engage or disengage with a container. A transceiver may be coupled to (i.e. provided on) the body and a further transceiver may be coupled to (i.e. provided on) the gripping device.

The load handling device may comprise a power source (e.g. a battery) for powering the load handling device (e.g. to power the receiver, the transmitter and/or the controller etc.). The power source may be provided on the body (e.g. a battery fitted in the body) and may be configured to power components within the body and/or components of the gripping device. Alternatively or in addition to the power source provided on the body, a power source may be provided on the gripping device (e.g. a battery fitted on the gripping device) and may be configured to power components of the gripping device and/or components within the body. The load handling device may comprise a power cable connecting a power source within the body to the gripping device, the power cable being configured to provide power from the power source within the body to the gripping device (e.g. to power the transmitter provided on the gripping device).

The receiver and the transmitter of the load handling device may be configured to be synchronised with each other such that the data from the transmitter can be received and correlated by the receiver. For example, the receiver may be configured to check for or sample the data sent by the transmitter as the transmitter sends its data, i.e. at the same time as the transmitter sends its data. The receiver may be configured to generate the assigned code as the transmitter sends its data (so as to correlate the data received by the transmitter). The receiver and the transmitter may each comprise a respective clock that may be synchronised with each other such that the receiver may generate the assigned code at the same time as the transmitter sends its data. The receiver clock and the transmitter clock may be configured to synchronise and/or re-synchronise when the gripping device is returned to the body (e.g. once the gripping device is raised and reunited with the body, or once the gripping device is returned to the fully raised position). This advantageously ensures and maintains synchronicity between the receiver and the transmitter and provides an efficient way of maintaining synchronicity between the receiver and the transmitter without the need for complex or highly sensitive clocks that may automatically maintain synchronicity. The receiver clock and the transmitter clock may be configured to synchronise and/or re-synchronise each time the gripping device is returned or reunited with the body. The controller may be configured to synchronise the receiver clock and the transmitter clock.

In some embodiments, the receiver and the transmitter may not require clocks in order to maintain synchronicity between the receiver and the transmitter. The receiver may be configured to generate the code multiple times as the transmitter sends its data. If the receiver generates the code out of sync with the code received from the transmitter, the receiver and the transmitter may result in no or low correlation and may prevent the receiver and the transmitter from locking together (i.e. the receiver fails to recognise the code from the transmitter). The receiver may disregard the data receiver from the transmitter and may not transfer the data for further processing (e.g. by the controller). The receiver may be configured to continue generating the code and cycling through the code starting at different points along the vector code. For example, the receiver may generate the code transposed or shifted along the vector code (e.g. by one chip), i.e. the receiver may start generating the code one chip after where it generated the code on the previous cycle. The receiver may be configured to continue generating the code until it synchronises (i.e. aligns) with the code transmitted by the transmitter (provided the transmitter is sending the same code). The codes may be configured to synchronise or align when the receiver code and the transmitter code start and end at the same number of chips and where each chip in the receiver code is mirrored by each chip in the transmitter code (i.e. the codes are correlated). The receiver and the transmitter may result in high correlation and may lock together (i.e. the receiver recognises the code from the transmitter). The receiver may retain the data received from the transmitter and may transfer the data for further processing (e.g. by the controller).

In another aspect, there is provided a system comprising:
a grid storage structure for accommodating containers stacked in stacks, the grid storage structure comprising a track system arranged in a grid pattern comprising a plurality of grid cells;
a plurality of load handling devices as described above.

By providing a system with a plurality of load handling devices where each load handling device is assigned a code, this advantageously prevents cross talk and interference between the load handling device, i.e. from the transmitters of other load handling devices in the system. The code assigned to each load handling device may be recognisable between the transmitter and the receiver of the same load handling device. The above communication system can ensure that only the data required to be read by the receiver of a given load handling device is recognised by the receiver. Preventing or reducing cross talk and interference between the load handling devices is particularly advantageous in systems comprising a plurality of load handling devices, each with their own transmitter and receiver, especially if data signal from the transmitter may be weak and/or if the transmitter may be configured to be moved away from the receiver such that the data signal from the transmitter may become weaker.

The system may comprise the communication manager. The communication manager may be configured to define and manage the codes assigned to the load handling devices (e.g. each load handling device). Each grid cell may be allocated a predetermined code which may be assigned to the load handling devices.

As described above, the load handling devices may be configured to move (i.e. travel) on the track system to specific grid cells (i.e. predetermined grid cell locations). Each load handling device may be configured to travel on the track system to a predetermined grid cell location, where the code allocated to the grid cell location may be assigned (i.e. respectively assigned) to each of the load handling devices.

The code for each grid cell may be unique, i.e. the codes assigned to the load handling devices may be unique to each load handling device. In other embodiments, the code for each grid cell may be locally unique, i.e. the code for a given grid cell may be different from the codes in adjacent grid cells. Adjacent grid cell locations may include one, two, three, four, five, six or more grid cells from the given grid cell location.

At least one of the codes allocated to the grid cells may be repeated across the grid cells. For example, a code allocated to a grid cell may repeat every other cell, or every other two, three, four, five, six or more cells in any direction (i.e. X-Y direction) across the grid cells. Thus, the codes may be recycled (i.e. used more than once) across the grid cells of the storage structure. This advantageously reduces the total number of codes required to cover the grid cells (e.g. all the grid cells) in the storage structure. This may be possible because the signal (i.e. the signal intensity or strength) from the transmitter may diminish or decay with increasing distance from the transmitter. Thus, cross talk between the load handling devices may only travel a limited distance. The signal from a transmitter may travel a maximum distance (i.e. a maximum crosstalk length). Beyond the maximum crosstalk length, the signal from a transmitter may not be received by a receiver. This allows the codes to be reused. A code may be reused every 2× the maximum crosstalk length across the grid cells. The codes allocated to the grid cells may repeat in a pattern (e.g. the same pattern) across the grid cells. A set number of unique codes may be allocated in a pattern to the grid cells (i.e. a pattern of codes). The pattern of codes may be repeated across the grid cells. For example, a set of 9 unique codes allocated to 9 grid cells in a 3×3 block of grid cells may be repeated every 3×3 blocks of grid cells. This further reduces the total number of codes required to cover the grid cells (e.g. all the grid cells) in the storage structure.

In another aspect, there is provided a method for controlling a load handling device, the method comprising the load handling device described above; the method comprising the step of:
assigning a code to the load handling device.

In another aspect, there is provided a method for controlling a system, the method comprising the system described above, the method comprising the steps of:
allocating a code to each grid cell;
assigning the codes to the load handling devices travelling on the track system.

The method may comprise the step of allocating a unique code to each grid cell. The method may comprise the step of allocating the same code to at least two of the grid cells. The method may comprise the step of allocating a plurality of codes to the grid cells in a pattern across the grid cells. The method may comprise the step of assigning a code to a load handling device once the load handling device has stopped in a predetermined grid cell location. The method may comprise the step of assigning the code allocated to a first grid cell location to the load handling device parked at the first grid cell location. The method may comprise the step of assigning the code allocated to a second grid cell location to the load handling device once the load handling device has moved to and parked at the second grid cell location. As each load handling device moves to a new grid cell location, the method may comprise the step of assigning the code allocated to the new grid cell location to the load handling device.

### BRIEF DESCRIPTION OF THE DRAWINGS

Aspects and example embodiments of the present invention will now be described with reference to the accompanying drawings.

FIG. 1 is a schematic perspective view of a grid storage structure and containers;

FIG. 2 is a schematic top view of a track system on top of the storage structure of FIG. 1;

FIG. 3 shows load handling devices on top of the storage structure of FIG. 1;

FIG. 4 is a schematic perspective view of a load handling device with a lifting assembly in a lowered configuration;

FIGS. 5A and 5B show schematic cutaway views of the load handling device of FIG. 4 with the lifting assembly in a raised and a lowered configuration;

FIG. 6 shows a schematic front view of a load handling device with an embodiment of communication system;

FIG. 7 shows a schematic front view of a load handling device with another embodiment of communication system;

FIG. 8 shows a schematic top view of a grid storage structure with grid cells and a schematic depiction of codes allocated to the grid cells of the storage structure;

FIG. 9A shows a schematic depiction of a code transmitted by a transmitter and received by a receiver when there is low correlation and no lock between the transmitter and the receiver; and

FIG. 9B shows a schematic depiction of the code transmitted by the transmitter and received by the receiver when there is high correlation and locking between the transmitter and the receiver.

### DETAILED DESCRIPTION

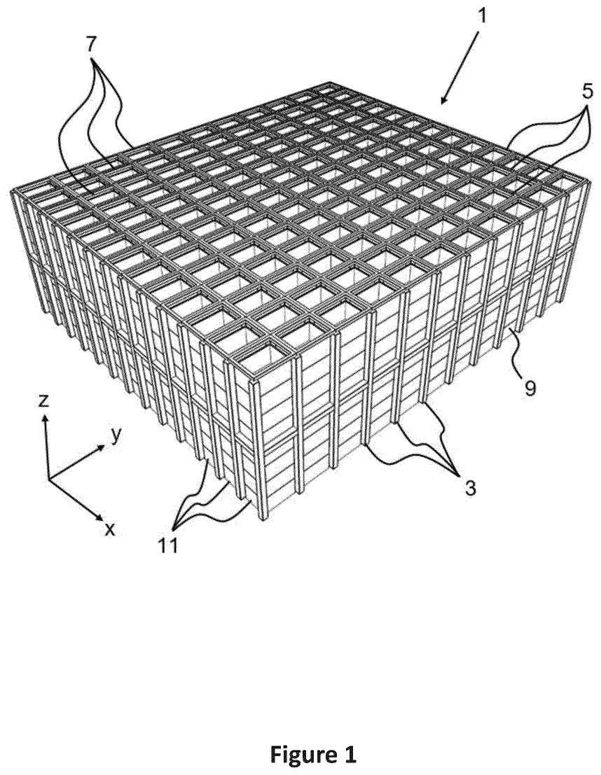

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern.

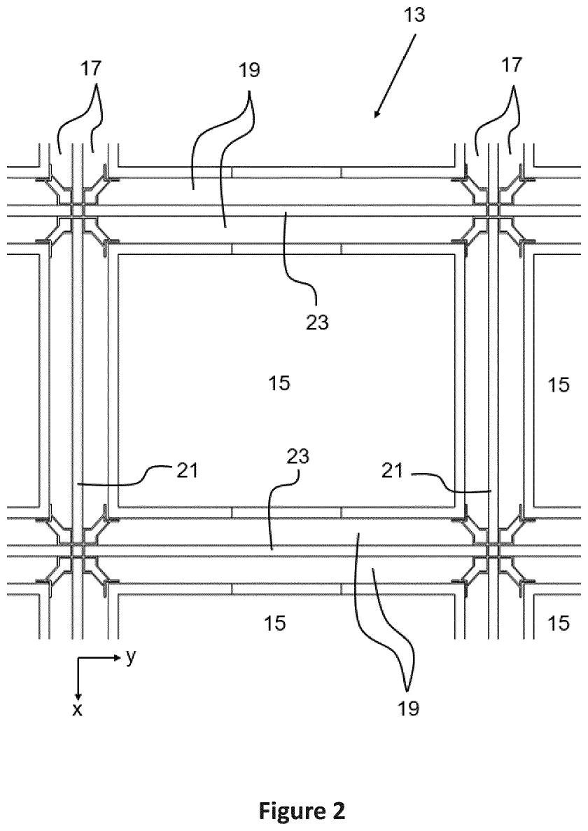

FIG. 2 shows a large-scale plan view of a section of track system 13 forming part of the storage structure 1 illustrated in FIG. 1 and located on top of the horizontal members 5, 7 of the storage structure 1 illustrated in FIG. 1. The track system 13 may be provided by the horizontal members 5, 7 themselves (e.g. formed in or on the surfaces of the horizontal members 5, 7) or by one or more additional components mounted on top of the horizontal members 5, 7. The illustrated track system 13 comprises x-direction tracks 17 and y-direction tracks 19, i.e. a first set of tracks 17 which extend in the x-direction and a second set of tracks 19 which extend in the y-direction 3, transverse to the tracks 17 in the first set of tracks 17. The track system 13 is arranged in a grid pattern comprising a plurality of grid cells 15, i.e. the tracks 17, 19 define apertures at the centres of the grid cells. Storage containers 9 are arranged in stacks 11 beneath the grid cells 15 defined by the grid pattern, one stack 11 of containers 9 per grid cell 15. The grid cells 15 are sized to allow containers 9 located beneath the grid cells 15 to be lifted and lowered through the apertures. The x-direction tracks 17 are provided in pairs separated by channels 21, and the y-direction tracks 19 are provided in pairs separated by channels 23. Other arrangements of track system may also be possible.

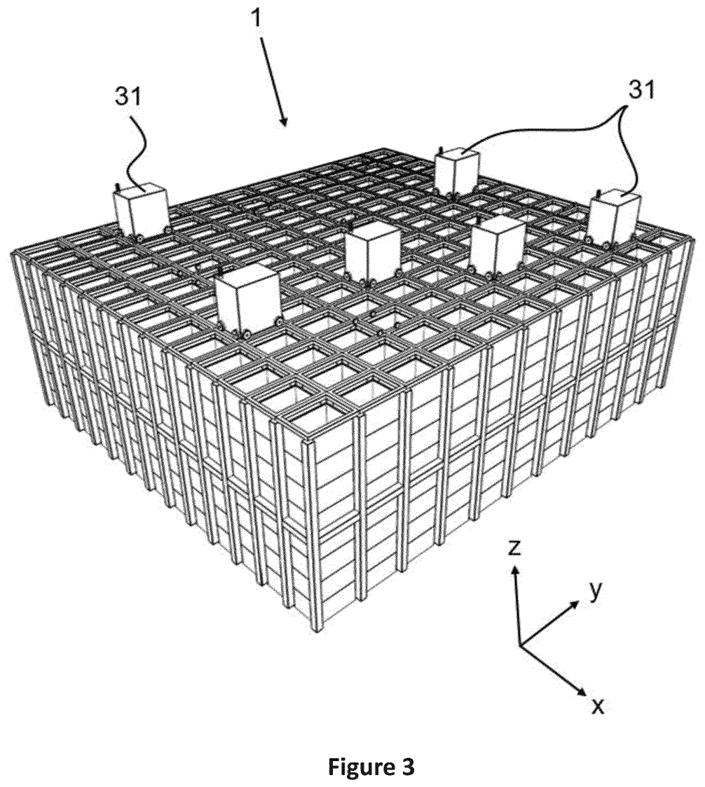

FIG. 3 shows a plurality of load handling devices 31 moving on top of the storage structure 1 illustrated in FIG. 1. The load handling devices 31, which may also be referred to as robots or bots, are provided with sets of wheels to engage with corresponding x- or y-direction tracks 17, 19 to enable the bots 31 to travel across the track system 13 and reach specific grid cells 15. The illustrated pairs of tracks 17, 19 separated by channels 21, 23 allow bots 31 to occupy (or pass one another on) neighbouring grid cells 15 without colliding with one another.

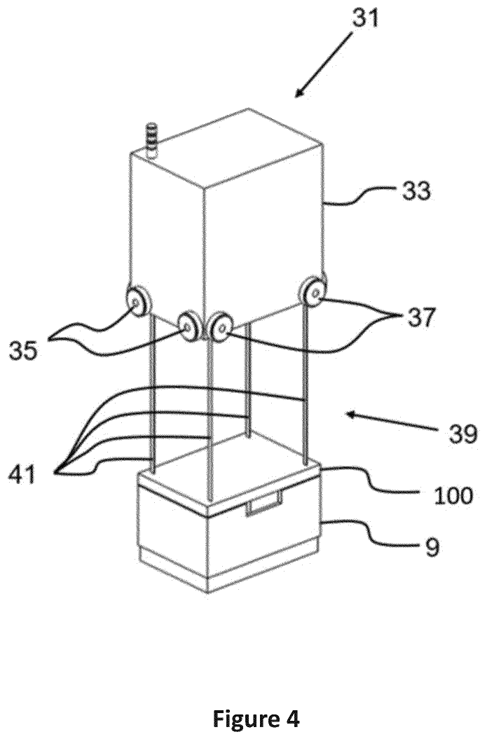

As illustrated in FIG. 4, a load handling device 31 comprises a body 33 in or on which are mounted one or more components which enable the load handling device 31 to perform its intended functions. These functions may include moving across the storage structure 1 on the track system 13 and raising or lowering containers 9 (e.g. from or to stacks 11) so that the load handling device 31 can retrieve or deposit containers 9 in specific grid cell 15 positions.

The illustrated load handling device 31 comprises first and second sets of wheels 35, 37 which are mounted on the body 33 of the load handling device 31 and enable the load handling device 31 to move in the x- and y-directions along the tracks 17 and 19, respectively. In particular, two wheels 35 are provided on the shorter side of the load handling device 31 visible in FIG. 4, and a further two wheels 35 are provided on the opposite shorter side of the load handling device 31 (not visible in FIG. 4). The wheels 35 engage with the tracks 17 and are rotatably mounted on the body 33 of the load handling device 31 to allow the load handling device 31 to move along the tracks 17. Analogously, two wheels 37 are provided on the longer side of the load handling device 31 visible in FIG. 4, and a further two wheels 37 are provided on the opposite longer side of the load handling device 31 (not visible in FIG. 4). The wheels 37 engage with the tracks 19 and are rotatably mounted on the body 33 of the load handling device 31 to allow the load handling device 31 to move along the tracks 19.

The load handling device 31 also comprises a lifting mechanism 39 configured to raise and lower containers 9. The illustrated lifting mechanism 39 comprises four tethers 41 which are connected at their lower ends to a gripping device 100. The tethers 41 may be in the form of cables, ropes, tapes, belts, seat belts or any other form of tether with the necessary physical properties to lift the containers 9. The gripping device 100 comprises at least one gripper assembly configured to engage with features of the containers 9. For example, the containers 9 may be provided with one or more apertures in their upper sides with which the gripper assembly can engage. Alternatively or additionally, the gripper assembly may be configured to hook under the rims or lips of the containers 9, and/or to clamp or grasp the containers 9. The tethers 41 may be wound up or down to raise or lower the gripping device 100, as required. One or more motors or other means may be provided to effect or control the winding up or down of the tethers 41.

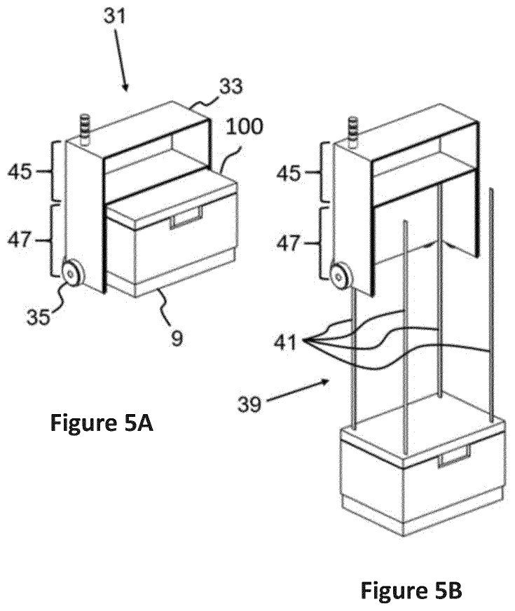

As can be seen in FIGS. 5A and 5B, the body 33 of the illustrated load handling device 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the lifting mechanism 39. The container-receiving space is sized such that enough of a container 9 can fit inside the cavity to enable the load handling device 31 to move across the track system 13 on top of storage structure 1 without the underside of the container 9 catching on the track system 13 or another part of the storage structure 1. When the load handling device 31 has reached its intended destination, i.e. a specific grid cell position, the lifting mechanism 39 controls the tethers 41 to lower the gripping device 100 and the corresponding container 9 out of the load handling device cavity and into the intended position. The intended position may be a stack 11 of containers 9 or an egress point of the storage structure 1 (or an ingress point of the storage structure 1 if the load handling device 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the load handling device 31.

To remove a container from the top of a stack 11, the load handling device 31 is moved as necessary in the X and Y directions so that the lifting mechanism 39 is positioned above the stack 11. The gripping device 100 is then lowered vertically in the Z direction until it reaches its fully lowered position (shown in FIG. 5B) and engages with a container 9 at the top of the stack 11. The gripping device 100 engages or grips the container 9 and is then pulled upwards by the tethers 41 with the container 9 attached. Once the gripping device 100 reaches its fully raised position (shown in FIG. 5A), the container 9 is accommodated within the body 33 and is held above the level of the tracks 17, 19. The load handling device 31 can be moved to a different position in the X-Y plane, carrying the container 9 along with it, to transport the container 9 to another location.

The container-receiving space of the load handling device 31 may not be within the body 33 of the load handling device 31. For example, the container-receiving space may instead be adjacent to the body 33 of the load handling device 31, e.g. in a cantilever arrangement with the weight of the body 33 of the load handling device 31 counterbalancing the weight of the container to be lifted. In such embodiments, a frame or arms of the lifting mechanism 39 may protrude horizontally from the body 33 of the load handling device 31, and the tethers 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the load handling device 31 may be chosen to provide a desired effect. For example, it may be preferable for the frame/arms to protrude at a high level on the body 33 of the load handling device 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track system 13) to keep the centre of mass of the load handling device 31 lower when the load handling device 31 is loaded with a container.

To enable the load handling device 31 to move on the different wheels 35, 37 in the first and second directions, the load handling device 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the load handling device 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the load handling device 31 stays substantially at the same height and therefore the weight of the body 33 and the components mounted thereon does not need to be lifted and lowered by the wheel-positioning mechanism.

A plurality of load handling devices 31 are provided on top of the storage structure where each load handling device 31 can operate simultaneously (as described above) to increase the throughput of the system. The containers 9 can be transferred by the load handling devices 31 to one or more ports or egress/ingress points (not shown) which transport the containers 9 in and out of the storage structure. Similarly, containers 9 can be transferred from the one or more ports/egress/ingress points to a stack 11 by the load handling devices 31.

As the gripping device 100 is raised and/or lowered from the body 33 of the load handling device 31, communication between the gripping device 100 and the body 33 may be useful. For example, in some embodiments, the gripping device 100 may communicate to the body 33 that it has reached the required position to lift a container (i.e. it has reached the fully lowered position) before the gripping device 100 is instructed to engage with the container.

In other embodiments, the gripping device 100 may communicate to the body 33 that it has engaged or dis-engaged with a container before the tethers can be wound to lift the gripping device 100. In some embodiments, the gripping device 100 may communicate to the body 33 the speed at which it is travelling (i.e. as it is being raised/lowered) and/or its position between the fully raised position and the fully lowered position. This information is useful so that the load handling device 31 can control the speed at which the gripping device 100 is travelling. For example, the load handling device 31 may be configured to decrease the speed of the gripping device 100 as it approaches its fully lowered position to ensure that the gripping device 100 is accurately lowered onto a container without damage to the gripping device 100. The load handling device 31 may be configured to decrease the speed of the gripping device 100 as it approaches its fully raised position to ensure that the gripping device 100 is accurately raised into the body 33 of the load handling device 31 without damage to the gripping device 100 or the body 33 of the load handling device 31. In some embodiments, the load handling device 31 may be configured to increase the speed of the gripping device 100 as it travels between its fully lowered position and its fully raised position to increase efficiency.

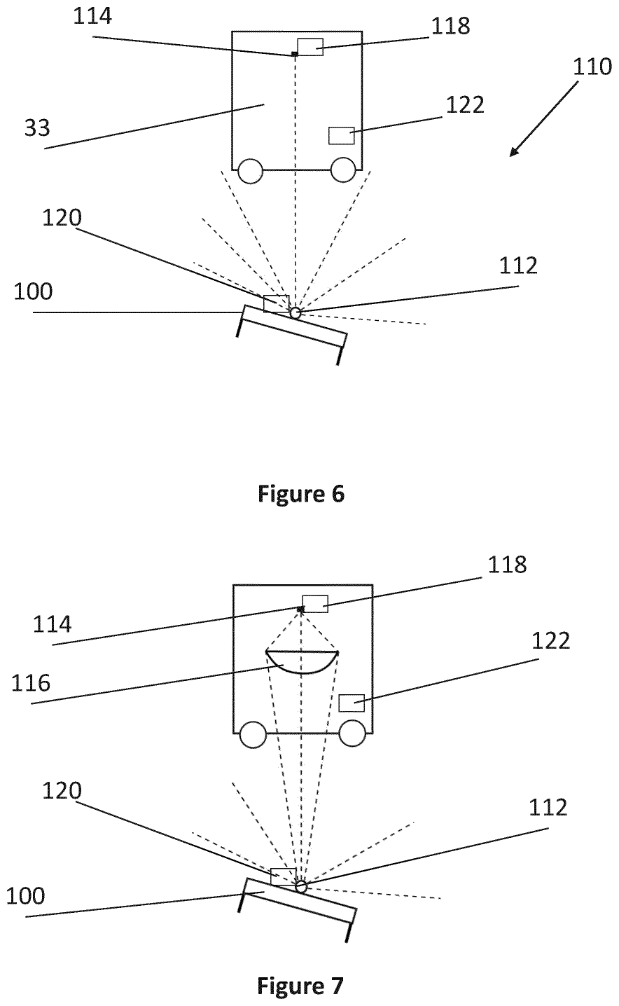

FIG. 6 shows a schematic front view of an embodiment of load handling device 31 with the gripping device 100 shown in a lowered position. The tethers connecting the gripping device 100 to the body 33 are not included in FIG. 6 for the sake of simplicity. The load handling device 31 comprises a transmitter 112 and a receiver 114 which enable communication (i.e. data transmission) between the body 33 and the gripping device 100. The transmitter 112 is coupled to the gripping device 100 and is configured to transmit data and the receiver 114 is coupled to the body 33 and is configured to receive the data from the transmitter 112.

The transmitter 112 and the receiver 114 are configured to communicate via wireless communication, in particular, an optical based communication. The transmitter 112 is a light transmitter 112 configured to transmit optical transmissions, for example a light emitting diode (LED), e.g. an infrared (IR) LED, and the receiver 114 is a light detector or a photo detector configured to detect the optical transmissions. Communication between the transmitter 112 and the detector is dependent on the light intensity and the blink of the transmitter 112.

The load handling device 31 includes a controller 122 which, in this embodiment, is provided on the load handling device 31 (i.e. in the body 33 of the load handling device 31) and is connectable to the receiver 114. The controller 122 is configured to control operation of (i.e. provide instructions to) the body 33 and/or the gripping device 100. The controller 122 is configured to interpret the data received by the receiver 114 (from the transmitter 112) and determine information about the gripping device 100 based on the data, including for example, the position of the gripping device 100 (e.g. between the fully raised position and the fully lowered position), whether the gripping device 100 is engaged and/or dis-engaged with a container, the speed at which it is travelling etc. Based on the information received, the controller 122 is configured to provide instructions to the body 33 and/or the gripping device 100, including for example, controlling the speed of the gripping device 100 as it travels, instructing the gripping device 100 to engage or dis-engage with a container etc.

FIG. 7 shows an embodiment of load handling device 31 where the receiver 114 includes a lens 116 for focusing the optical transmissions (i.e. the data) from the transmitter 112 onto the receiver 114. In the embodiments of FIGS. 6 and 7, the transmitter 112 comprises an omnidirectional light transmitter 112 configured to transmit the optical transmissions in a plurality of directions, i.e. in a 180° circumference around the transmitter 112. The lens 116 helps to ensure that the optical transmissions are focused onto the receiver 114 such that the receiver 114 can pick up the data.

The load handling device 31 of FIGS. 6 and 7 comprises a power source (not shown) fitted in the body 33 and configured to power components within the body 33, including the receiver 114. The load handling device 31 also comprises a power source (not shown) on the gripping device 100 and configured to power components of the gripping device 100, including the transmitter 112. As such, the gripping device 100 is a self-powered gripping device 100. However, in other embodiments, a power source may be provided solely within the body 33 for powering components within the body 33 and a power cable may be provided connecting the power source within the body 33 to the gripping device 100 for powering the components of the gripping device 100.

As shown in FIG. 1, the storage structure includes a plurality of load handling devices 31 moving on top of the storage structure. At least some of the load handling devices 31 in the storage structure include a transmitter 112 and a receiver 114 as described above. In some embodiments, each of the load handling devices 31 in the storage structure includes a transmitter 112 and a receiver 114 as described above.

Where multiple load handling devices 31 are provided each including a transmitter 112 and a receiver 114, the risk of interference and cross talk between the load handling devices 31 increases, e.g. optical transmissions (i.e. data) from the transmitter 112 of one load handling device 31 may be received by the receiver 114 of another load handling device 31.

To prevent interference and cross talk between the various load handling devices 31, each load handling device 31 is assigned a code generated using code division multiple access (CDMA). The code assigned to the load handling device 31 is recognisable between the transmitter 112 and the receiver 114 of the load handling device 31. The transmitter 112 of the load handling device 31 transmits the code along with the data and the receiver 114 discards any received data not comprising the code.

The code assigned to the load handling device 31 is a vector consisting of 1s and 0s (ie. chips) and for each bit of data sent by the transmitter 112, the data is modulated by the code assigned to the load handling device 31. In this embodiment, the transmitter 112 transmits light during the 1 chip elements of the code and transmits no light during the 0 chip elements of the code. In turn, the receiver 114 of the same load handling device 31 generates its own copy of the code assigned to the load handling device 31 and multiplies the data received from the transmitter 112 by the vector code. Where the value obtained by the multiplication is a large positive number, the receiver 114 correlates the data received by the transmitter 112 and sends the data to the controller 122 for processing. Where the value obtained by the multiplication is a large negative number, the receiver 114 does not correlate the data received by the transmitter 112 and the receiver 114 discards the data. This ensures that a receiver 114 only correlates and recognises data from a transmitter 112 belonging to the same load handling device 31 and that has been assigned the same code as the receiver 114. By ensuring that the receiver 114 only correlates data from a transmitter 112 belonging to the same load handling device 31, this prevents cross talk from other load handling devices 31 (i.e. their transmitter 112s) that are in the vicinity of a particular load handling device 31.

As described above, to remove a container from the top of a stack or to deposit a target container (e.g. onto the top of a stack or at another location), the load handling devices 31 are configured to move on the track system 13 as necessary in the X and Y directions until a load handling device 31 reaches a predetermined grid cell location such that the gripping device 100 is positioned above the required location to remove or deposit the container.

Each grid cell 15 in the storage structure is allocated a predetermined code which is assigned to the load handling devices 31 travelling on the track system 13. In particular, the code allocated to a given grid cell 15 is assigned to the load handling device 31 that stops or parks on the (given) grid cell 15 (e.g. a first grid cell 15) to retrieve or deposit the target container. As such, the code assigned to each load handling device 31 is dependent on the grid cell location of the load handling device 31, i.e. the grid cell 15 on which the load handling device 31 is located in order to remove/deposit the target container. Once the load handling device 31 moves to a different grid cell location (e.g. a second grid cell 15), for example to retrieve or deposit a container to a different stack, the load handling device 31 is assigned the code allocated to the new grid cell location of the load handling device 31 (i.e. the second grid cell 15). Each time the load handling device 31 moves to a different grid cell location, the load handling device 31 is assigned the code allocated to the new grid cell location of the load handling device 31.

The load handling device 31 comprises a communications interface configured to assign the code from an external communication manager. The code is assigned to the load handling device 31 once the load handling device 31 has stopped or parked on the predetermined grid cell location. However, in other embodiments, the code can be assigned before the load handling device 31 stops/parks at the predetermined grid cell location, e.g. once the communication manager has determined the predetermined grid cell location of the load handling device 31.

In some embodiments, each grid cell 15 in the storage structure is allocated a unique code. This may require a large number of unique codes in order to cover all the grid cells 15 in the storage structure. For a given chip length, a limited number of unique codes can be generated. To increase the number of available unique codes, the chip length of the code can be increased, i.e. a 20 chip long vector code will produce a larger number of unique codes compared to a 10 chip long vector code.

In other embodiments, the code for each grid cell 15 is locally unique, i.e. the code for a given grid cell 15 is different from the codes in adjacent grid cells 15.

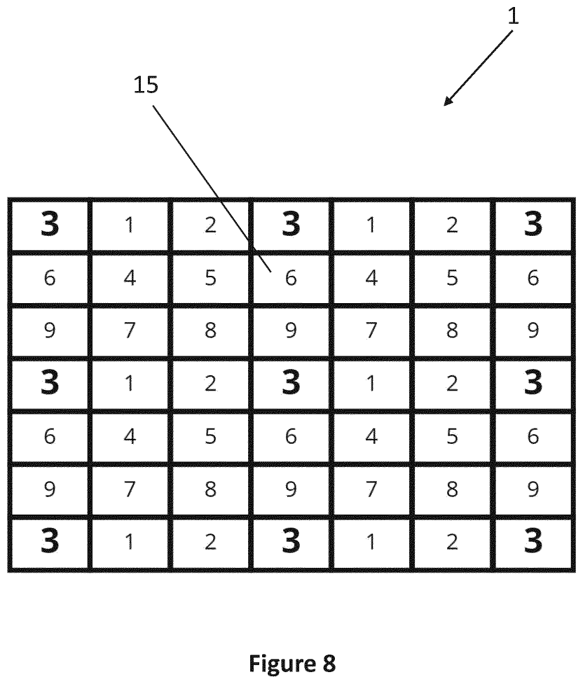

FIG. 8 shows a schematic top view of a grid storage structure with grid cells 15 and a schematic depiction of the codes allocated to the grid cells 15 of the storage structure. In this embodiment, the codes are repeated across the grid cells 15. For example, the code ‘3’ is used for multiple grid cells 15. The codes are locally unique, i.e. the grid cells 15 adjacent (in both the X and Y directions) to a grid cell 15 allocated with the code ‘3’ are allocated different codes. In this embodiment, two grid cells 15 adjacent (in the X and Y directions) to a grid cell 15 allocated the code ‘3’ are allocated different codes, i.e. the same code is repeated every three grid cells 15. The codes allocated to each grid cell 15 are respectively assigned to the load handling devices 31 parked on the grid cells 15. This prevents interference from the transmitter 112s on the load handling devices 31 in the adjacent grid cells 15, i.e. the receiver 114 on the load handling device 31 parked on the grid cell 15 allocated with the code ‘3’ will not recognise or correlate with the data received from the transmitter 112s on the load handling devices 31 parked in the adjacent grid cells 15. The signal from the transmitter 112s diminishes with increasing distance from the transmitter 112 such that beyond a maximum travel distance (i.e. the maximum crosstalk length of the transmitter 112), the signal from a transmitter 112 is no longer detectable or receivable by a receiver 114. This allows the code ‘3’ to be reused and allocated to another grid cell 15 that is located beyond the maximum crosstalk length, without causing interference. In this embodiment, the distance between two grid cells 15 allocated with the same code (e.g. code ‘3’) is 2× the maximum crosstalk length of the transmitter 112s. However, in other embodiments, the distance between two grid cells 15 allocated with the same code may be shorter (e.g. 1× the maximum crosstalk length) or longer (e.g. 3×, 4×, 5×, 6×, 8×, 10×, 20× etc. the maximum crosstalk length).

In the embodiment of FIG. 8, a plurality of codes are repeated across the grid cells 15. In particular, the codes allocated to the grid cells 15 are repeated in a pattern across the grid cells 15. As shown by FIG. 8, a set of 9 unique codes are allocated in a pattern to nine grid cells 15 across the storage structure. The codes 1, 2, 3, 4, 5, 6, 7, 8 and 9 are allocated to nine grid cells 15 in a 3×3 block of grid cells 15 and are repeated every 3×3 blocks of grid cells 15 in the same pattern across the grid cells 15.

The skilled person will appreciate that, in other embodiments, any set number of unique codes can be allocated in a pattern to the grid cells 15.

In the schematic depiction of FIG. 8, the codes are represented by single digit numbers (1, 2, 3, 4, 5, 6, 7, 8 and 9) for the sake of simplicity. However, each code includes a vector consisting of chips, e.g. 2, 3, 4, 5, 6, 8, 10, 20, 30, 40, 50, 60, 61, 63 etc. chip long vectors. The following is an example of 9 codes each comprising 63 chip long vectors that can be allocated to the grid cells 15:

Example code 1:
11111101010110011011101101001001110001011110010100011000010000
Example code 2:
00010000010010010000100111101101001101011000101101111011111011
Example code 3:
01001001000110110111000111011010000001000101110010010110111111
Example code 4:
11011100001111001111001010101001000110010010001001000111111101
Example code 5:
10111111100100110010100010001000011111000110101110100111001010
Example code 6:
01111000110011001001110011001010101101101111100001100110100100
Example code 7:
01011001101010011101010100101010011010100011111100111001001001
Example code 8:
01101110100110000000001011000111011110101000110110011101110101
Example code 9:
01100011010101000111011100111100001111101010000100110100111010

The above codes can be allocated in a repeating pattern across the grid cells 15 of the storage structure. In the above example codes, each code (i.e. Chirp) is a 63 bit long gold code. Furthermore, each code is balanced, i.e. the magnitude of each code sum is not greater than 1. The skilled person will appreciate that the above codes are examples only. The skilled person will know of a number of ways to generate suitable codes for the grid cells 15 of any bit or chip length.

In some embodiments, the receiver 114 and the transmitter 112 of a load handling device 31 need to be synchronised in order for the receiver 114 and the transmitter 112 to communicate with each other and for the receiver 114 to receive and recognise (i.e. correlate) the data from the transmitter 112. In particular, the receiver 114 is configured to generate the (assigned) code as the transmitter 112 sends its data. To enable this, the receiver 114 and the transmitter 112 each comprise a respective clock 118, 120 that can synchronise with each other.

In order to maintain synchronicity between the receiver 114 and the transmitter 112, their clocks 118, 120 may need to re-synchronise with each other (e.g. within a given time interval). In some cases, as the gripping device 100 moves away from the body 33 (e.g. as it is lowered towards a target container), synchronicity between the receiver 114 and the transmitter 112 may be lost. To maintain or recover synchronicity between these two parts, the receiver clock 118 and the transmitter clock 120 are configured to synchronise and re-synchronise each time the gripping device 100 is raised and reunited back to the body 33. Once the gripping device 100 is reunited with the body 33, the controller 122 is configured to synchronise the receiver clock 118 with the transmitter clock 120.

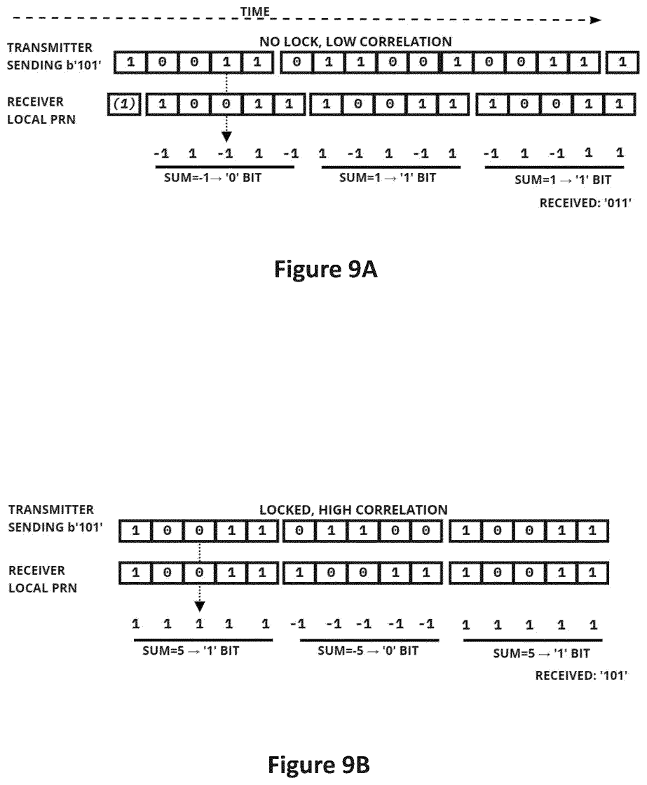

In some embodiments, the receiver 114 is configured to generate the (assigned) code multiple times as the transmitter 112 sends its data. If the receiver 114 generates the code out of sync with the transmitter 112 sending its data, the receiver 114 and the transmitter 112 cannot correlate and the receiver 114 will not recognise the data from the transmitter 112. FIG. 9A shows the receiver 114 generating the example vector code ‘10011’ multiple times as the transmitter 112 sends it data. As shown by FIG. 9A, the receiver 114 generates the code out of sync with the code received from the transmitter 112 resulting in the receiver 114 and the transmitter 112 having no or low correlation and the receiver 114 and the transmitter 112 not locking together (i.e. the receiver 114 fails to recognise the code from the transmitter 112). The receiver 114 disregards the data received and does not transfer the data to the controller 122 for further processing. The receiver 114 continues to generate the code and as it generates the code, it cycles through the vector code starting at different points along the vector code. In particular, the receiver 114 generates the vector code transposed or shifted along the vector code by one chip. As shown by FIG. 9B, if the receiver 114 has the same code as the transmitter 112, the vector code generated by the receiver 114 will eventually synchronise or align with the code being transmitted by the transmitter 112, resulting in the receiver 114 and the transmitter 112 having high correlation and the receiver 114 and the transmitter 112 locking together (i.e. the receiver 114 recognises the code from the transmitter 112). The receiver 114 retains the data received and transmits it to the controller 122 for further processing.

By providing a load handling device 31 where the receiver 114 is configured to generate the code multiple times as the transmitter 112 sends its data, until the code from the receiver 114 synchronises and aligns with the code sent by the transmitter 112, the receiver 114 can advantageously correlate and recognise the code from the transmitter 112 without the need for a receiver clock and a transmitter clock to be synchronised. A load handling device 31 employing the method shown in FIGS. 9A and 9B is thus not required to synchronise a receiver clock and a transmitter clock each time the gripping device 100 is reunited with the body 33.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

1-28. (canceled)

29. A load handling device for lifting and moving containers stacked in stacks in a grid storage structure including a track system, wherein the track system is arranged in a grid pattern above the stacks of containers, the track system including a grid with a plurality of grid cells, the load handling device being configured to travel on the track system to a predetermined grid cell location, the load handling device comprising:
a vehicle body and a gripping device, wherein the gripping device is configured to be lowered away from the vehicle body and raised back to the vehicle body;
an optical transmitter coupled to the gripping device configured to transmit data from the gripping device to the vehicle body; and
an optical receiver coupled to the vehicle body configured to receive the data from the transmitter;
wherein each grid cell is allocated a predetermined code, the load handling device being configured to receive a predetermined code of a predetermined grid cell which is assigned to the load handling device, the optical transmitter being configured to transmit the predetermined code along with data from the gripping device, and the receiver is configured to discard received data not including the predetermined code.

30. A load handling device according to claim 29, wherein the transmitter is configured to send its data modulated by the assigned predetermined code, and wherein the receiver is configured to correlate the data received by the transmitter such that the receiver is configured to recognise only data received from a transmitter whose data it has correlated with.

31. A load handling device according to claim 29, wherein the predetermined code for each grid cell is locally unique.

32. A load handling device according to claim 31, wherein predetermined codes allocated to the grid cells repeat in a pattern across the grid cells.

33. A load handling device according to claim 29, wherein the load handling device comprises:
a communications interface configured to assign the predetermined code from an external communication manager.

34. A load handling device according to claim 33, wherein the communications interface is configured to assign the predetermined code to the load handling device once the load handling device has stopped at a predetermined grid cell location allocated to the predetermined code.

35. A load handling device according to claim 33, wherein the load handling device is configured to move to a first predetermined grid cell location where the load handling device is assigned the predetermined code allocated to the first predetermined grid cell location, and where the load handling device is configured to move to a second predetermined grid cell location where the load handling device is assigned a predetermined code allocated to the second grid cell location.

36. A load handling device according to claim 29, wherein the receiver and the transmitter are configured to be synchronised with each other, such that the receiver is configured to generate the predetermined code assigned to the load handling device at the same time as the transmitter sends its data.

37. A load handling device according to claim 29, wherein the receiver and the transmitter each comprise:
a respective clock, wherein the clocks are synchronised with each other.

38. A load handling device according to claim 37, wherein the receiver clock and the transmitter clock are configured to synchronise as the gripping device is returned back to the body.

39. A load handling device according to claim 37, wherein the load handling device comprises:
a controller connectable to the receiver and configured to interpret data received by the receiver, the controller being configured to provide instructions to the gripping device based on the data received.

40. A load handling device according to claim 29, in combination with a system comprising:
a grid storage structure for accommodating containers stacked in stacks, the grid storage structure including a track system arranged in a grid pattern including a grid with a plurality of grid cells, the track system being arranged above the stacks of containers, wherein each grid cell is allocated a predetermined code; and
a plurality of the load handling devices, wherein one or more of the plurality of load handling devices are configured to travel on the track system to predetermined grid cell locations, wherein the predetermined codes allocated to the grid cells are assigned to load handling devices.

41. A system according to claim 40, wherein the predetermined code for each grid cell is locally unique.

42. A system according to claim 41, wherein the predetermined codes allocated to the grid cells repeat in a pattern across the grid cells.

43. A system according to claim 40, wherein the system comprises:
a communication manager configured to define and manage the predetermined codes assigned to the load handling devices.

44. A system according to claim 40, wherein a set number of unique predetermined codes are allocated in a pattern to the grid cells, and wherein the pattern of predetermined codes is repeated across the grid cells.

45. A system according to claim 40, wherein the predetermined codes are assigned to the load handling devices once they have stopped in the predetermined grid cell locations.

46. A system according to claim 40, wherein each load handling device is configured to move to a first predetermined grid cell location where the load handling device is assigned the predetermined code allocated to the first predetermined grid cell location, and where each load handling device is configured to move to a second predetermined grid location where the load handling device is assigned the predetermined code allocated to the second grid cell location.

47. A method for controlling a load handling device for lifting and moving containers stacked in stacks in a grid storage structure including a track system, wherein the track system is arranged in a grid pattern above the stacks of containers, the track system including a grid with a plurality of grid cells, the load handling device being configured to travel on the track system to a predetermined grid cell location, the load handling device including:
a vehicle body and a gripping device, wherein the gripping device is configured to be lowered away from the vehicle body and raised back to the vehicle body;
an optical transmitter coupled to the gripping device configured to transmit data from the gripping device to the vehicle body; and
an optical receiver coupled to the vehicle body configured to receive the data from the transmitter;
wherein each grid cell is allocated a predetermined code, the load handling device being configured to receive a predetermined code of a predetermined grid cell which is assigned to the load handling device, the optical transmitter being configured to transmit the predetermined code along with data from the gripping device, and the receiver is configured to discard received data not including the predetermined code, the method comprising:
assigning a predetermined code to the load handling device.

48. A method for controlling a load handling device in combination with a system including:
a grid storage structure for accommodating containers stacked in stacks, the grid storage structure including a track system arranged in a grid pattern including a grid with a plurality of grid cells, the track system being arranged above the stacks of containers, wherein each grid cell is allocated a predetermined code; and
a plurality of the load handling devices, wherein one or more of the plurality of load handling devices are configured to travel on the track system to predetermined grid cell locations, wherein the predetermined codes allocated to the grid cells are assigned to load handling devices, the method comprising:
allocating a predetermined code to each grid cell; and
assigning the predetermined codes to the load handling devices travelling on the track system.
